(19) United States
(12) Patent Application Publication
(10) Pub. No.: US 2023/0216530 A1
(43) Pub. Date: Jul. 6, 2023

(54) BULK INTERFERENCE GROUP RECOVERY IN FULL DUPLEX CATV ARCHITECTURES

(71) Applicant: ARRIS Enterprises LLC, Suwanee, GA (US)

(72) Inventor: Ayham AL-BANNA, Irving, TX (US)

(73) Assignee: ARRIS Enterprises LLC, Suwanee, GA (US)

(21) Appl. No.: 18/092,891

(22) Filed: Jan. 3, 2023

Related U.S. Application Data
(60) Provisional application No. 63/295,828, filed on Dec. 31, 2021.

(51) Int. Cl. H04B 1/10; H04N 21/61

(52) U.S. Cl. CPC H04B 1/1027; H04N 21/6118; H04N 21/6168

(57) ABSTRACT

Systems and methods in a full duplex transmission network that selectively perform periodic sounding tests to determine an optimal interference group arrangement of cable modems, and stores a redundant copy of the latest optimal interference group arrangement for recovery after a system reset/reboot.

### CROSS REFERENCE TO RELATED APPLICATIONS

The present application claims priority to U.S. Provisional App. No. 63/295,828 filed Dec. 31, 2021, the contents of which are each incorporated herein by reference in their entirety.

### BACKGROUND

The subject matter of this application relates to systems and methods that organize groups of cable modems into Interference Groups to facilitate full duplex transmission in CATV architectures.

Cable Television (CATV) services provide content to large groups of subscribers from a central delivery unit, called a “head end,” which distributes channels of content to its subscribers from this central unit through a branch network comprising a multitude of intermediate nodes. Modern Cable Television (CATV) service networks, however, not only provide media content such as television channels and music channels to a customer, but also provide a host of digital communication services such as Internet Service, Video-on-Demand, telephone service such as VoIP, and so forth. These digital communication services, in turn, require not only communication in a downstream direction from the head end, through the intermediate nodes and to a subscriber, but also require communication in an upstream direction from a subscriber and to the content provider through the branch network.

To this end, CATV head ends have historically included a separate Cable Modem Termination System (CMTS), used to provide high speed data services, such as video, cable Internet, Voice over Internet Protocol, etc. to cable subscribers. Typically, a CMTS will include both Ethernet interfaces (or other more traditional high-speed data interfaces) as well as RF interfaces so that traffic coming from the Internet can be routed (or bridged) through the Ethernet interface, through the CMTS, and then onto the optical RF interfaces that are connected to the cable company's hybrid fiber coax (HFC) system. Downstream traffic is delivered from the CMTS to a cable modem in a subscriber's home, while upstream traffic is delivered from a cable modem in a subscriber's home back to the CMTS. Many modern CATV systems have combined the functionality of the CMTS with the video delivery system (EdgeQAM) in a single platform called the Converged Cable Access Platform (CCAP). Still other modern CATV systems called Remote PHY (or R-PHY) relocate the physical layer (PHY) of a traditional CCAP by pushing it to the network's fiber nodes. Thus, while the core in the CCAP performs the higher layer processing, the R-PHY device in the node converts the downstream data sent by the core from digital-to-analog to be transmitted on radio frequency, and converts the upstream RF data sent by cable modems from analog-to-digital format to be transmitted optically to the core.

Regardless of which such architectures were employed, historical implementations of CATV systems bifurcated available bandwidth into upstream and downstream transmissions, i.e. data was only transmitted in one direction across any part of the spectrum. For example, early iterations of the Data Over Cable Service Interface Specification (DOCSIS) specified assigned upstream transmissions to a frequency spectrum between 5 MHz and 42 MHz and assigned downstream transmissions to a frequency spectrum between 50 MHz and 750 MHz. Though later iterations of the DOCSIS standard expanded the width of the spectrum reserved for each of the upstream and downstream transmission paths, the spectrum assigned to each respective direction did not overlap.

Recently, cable operators have searched for alternative architectures to deliver multi-gigabit services. This need, together with recent trends in the cable industry such as deployment of DOCSIS 3.1 Orthogonal Frequency Division Multiplexing (OFDM), deep fiber migration, and remote PHY network architectures, have resulted in the development and standardization of the full duplex (FDX) DOCSIS technology. With FDX DOCSIS, upstream and downstream spectrum is no longer separated, allowing up to 5 Gbps upstream service and 10 Gbps downstream service over the cable access network. In a full duplex system, because the CCAP/R-PHY core knows the characteristics of its own downstream transmission, it can distinguish upstream communications transmitted in the same frequencies that it provides those downstream services.

In FDX systems, however, interference between the bi-directional transmissions must be mitigated for the intended downstream signals to be properly received. In a point-to-multi-point system, where multiple cable modems (CMs) are connected to the same Cable Modem Termination System (CMTS) port, when one CM transmits upstream to the CMTS, the upstream signal may leak through the cable plant and interfere with reception of downstream signals received by other cable modems. Since the source of the interference is unknown to the receiving cable modem, techniques such as PHY layer echo cancellation cannot be used.

What is desired, therefore, are improved systems and methods for mitigating interference in full duplex CATV transmission architectures.

### BRIEF DESCRIPTION OF THE DRAWINGS

For a better understanding of the invention, and to show how the same may be carried into effect, reference will now be made, by way of example, to the accompanying drawings, in which:

FIG. 1 shows an exemplary full duplex R-PHY CATV architecture where many individual cable modems, each connected to a CCAP core through a branch network of RPD devices, are sorted into Interference Groups organized to minimize interference in the downstream signal caused by upstream transmissions.

FIG. 2 shows an exemplary method for determining whether to perform a full sounding test based on a baseline sounding test.

FIG. 3 shows an exemplary system that uses a current baseline sounding test and a selection from a plurality of different records of historical baseline sounding tests to determine whether to perform a full sounding test.

FIG. 4 shows an exemplary table of historical baseline sounding tests used by the system of FIG. 3.

FIG. 5 shows a method used by the system of FIG. 3 to determine whether to perform a full sounding test.

FIG. 6 shows an alternate architecture to that of FIG. 3.

### DETAILED DESCRIPTION

As already noted, the DOCSIS specification has historically used different frequency bands for upstream and downstream data traffic. Even though multiple cable modems in a given service group share the same network resources, the upstream and downstream traffic are completely isolated. Recently, in an attempt to offer symmetric services in both upstream and downstream, new FDX (Full Duplex) standards have been introduced to use a portion of the coaxial network bandwidth simultaneously for both upstream and downstream traffic. In an FDX architecture, the CMTS will simultaneously receive and transmit in the same FDX spectrum, while FDX Cable modems can either receive or transmit in the same FDX spectrum, but not both. The FDX band is divided into sub-bands, and the CMTS assigns which sub-band(s) each cable modem uses for upstream or downstream operation. This is referred to as a resource block assignment (RBA). Different cable modems will have different bandwidth demand for both the upstream and downstream directions, which can change over time, and FDX accordingly allows for the RBA to be changed dynamically. Thus, communication is full duplex from the perspective of the CMTS but is frequency division duplex from the perspective of the cable modem.

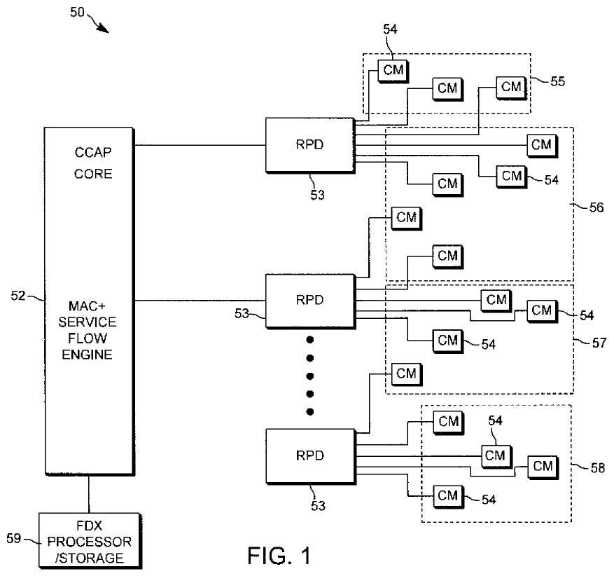

However, in an FDX architecture, RF signals from a modem transmitting data in the upstream direction can interfere with other modems receiving data in the downstream direction. Such interference can be minimized by organizing modems into Interference Groups. Referring to FIG. 1, for example, a CATV transmission architecture 50 may include a CCAP 52 at a head end connected to a plurality of cable modems 54 via a branched transmission network. The architecture of FIG. 1 is shown as an R-PHY system where the CMTS operates as the CCAP core while Remote Physical Devices (RPDs) 53 are located downstream, but alternate systems may use a traditional CCAP operating fully in an Integrated CMTS in a head end, connected to the cable modems 54 via a plurality of nodes/amplifiers.

Preferably, to facilitate FDX transmission, the cable modems are organized into Interference Groups (IGs) 55, 56, 57, 58, etc. As the name indicates, an IG is a collection or group of modems where the upstream transmission of one or more of the modems in the IG will unacceptably interfere with downstream reception of other modems in the IG, but will not unacceptably interfere with downstream transmissions of cable modems in any other IG. Identifying these IGs and using the IG groups to appropriately schedule downstream and upstream transmissions is crucial to achieving high throughput in FDX systems by allowing the CCAP to schedule downstream transmissions to all cable modems in an IG at a time when no cable modem in that IG is transmitting in the upstream direction.

To facilitate organization of cable modems into IGs, a sounding technique may be used to measure the interference caused to other cable modems in a network by the upstream transmissions a particular cable modem. During sounding, a given modem sends out pilot signals in the upstream while the rest of the modems in the service group measure their downstream modulation error rate (RxMER). This process is repeated by different transmitting modems resulting in a matrix showing the co-channel interference for the whole service group.

In some embodiments, sounding data may be collected from a large number of service groups from several CCAP cores, and the collected data may be processed in a centralized processor/storage 59 shown in FIG. 1 to organize the cable modems into respective IGs. Therefore, there is a need for highly efficient algorithms that can scale with a very large number of SGs. In addition, data may be collected repeatedly from the same set of SGs. This necessitates algorithms that can efficiently handle the incremental data

While the foregoing systems and methods redress inefficiencies in processing sounding data to dynamically assign cable modems to one or more Interference Groups (IGs), the sounding process itself imposes significant overhead on the transmission system. As noted above, a sounding procedure requires that the CMTS directs one or more FDX capable CMs to transmit test signals on designated subcarriers, while directing other FDX capable CMs to measure and report the received Transmission Modulation Error Ratio (RxMER) on the same set of subcarriers. The CMTS repeats this procedure using other CMs as transmitters until the interference levels are tested between all CM combinations. Further, the CMTS may repeat this on all relevant subcarriers.

There are two types of sounding typically employed in FDX systems-Continuous Wave (CW) sounding and OFDMA Upstream Data Profile (OUDP) sounding. During CW sounding, one or multiple test cable modems send CW test signals at selected subcarrier frequency locations (cable modems each support up to 255 subcarriers), while the rest of the cable modems measure the RxMER of a zero-bit-loaded downstream signal received concurrently with the upstream test transmission. These measurements include up to 3800 subcarriers, including ideally the subcarriers of the test CW signals. The advantage of CW sounding is that it ties up a relatively small number of subcarrier frequencies at one time, since interference at those frequencies is tested independently. This allows use of the remainder of the subcarriers for delivery of content. The disadvantage of CW sounding is the length of time that it takes to complete the procedure, which can take up to several minutes. During this time, the full use of the available spectrum is precluded.

OUDP sounding, conversely, occupies the entire spectrum for every test burst from each cable modem, where test bursts may last approximately 20-60 ms, where each test burst includes 3800 measurements, one for each 50 KHz band within the spectrum. Even repeated for a large number of modems, the entire procedure is still much faster than CW sounding. But this procedure prevents any use of the appropriate OFDM spectrum of the CATV plant during an OUDP test burst, since that burst spans the entire OFDM channel. Regardless of whether CW or OUDP sounding is utilized, at peak times of the day a customer could experience jitter or diminished bandwidth due to rounds of sounding.

Disclosed are novel systems and methods that reduce the frequency with which either of the foregoing types of sounding are required. This procedure invokes what will be referred to in this specification as a “baseline” sounding test in which all cable modems measure noise levels present when no signal is being sent in either the upstream or downstream direction. In this procedure, a “baseline CW” test collects, for each cable modem, a noise measurement in each subcarrier frequency utilized by the cable modem while no signal is being sent by any cable modem. A “baseline OUDP” test collects, for each cable modem, 3800 measurements at 50 KHz increments throughout the spectrum utilized by the system. Compared to full sounding procedures like CW and OUDP sounding, baseline sounding consumes far less system resources. Baseline sounding essentially measures noise floors in the transmission path between a head end and the customers' cable modems caused by factors such as standing wave reflections along the transmission path and spurious electromagnetic interference that varies based on the length of a transmission path, ambient weather conditions such as temperature, etc. Many of these factors, however, do not change with time, e.g. transmission length between a head end and a given cable modem, and when changes do occur between sequential baseline sounding measurements, these changes are strongly correlated with network topology changes such as when a cable modem from a customer comes or goes offline, which are frequently the source of changes between full sounding measurements. Thus, the present inventors realized that instead of simply using a periodic sequence of full sounding tests, the disclosed baseline sounding procedure could be used to determine whether a full sounding was needed.

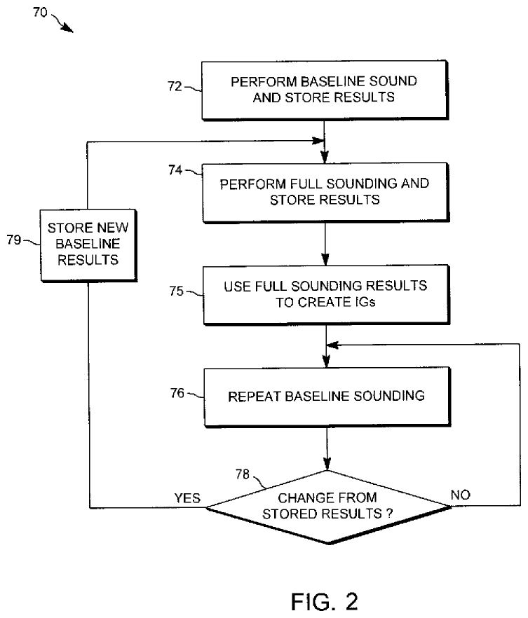

Referring specifically to FIG. 2, a system such as the one disclosed in FIG. 1 may use a method 70 that performs a baseline sounding test and stores the results at step 72. The baseline sounding test spans all 3800 frequencies of the OFDM/OFDMA band while no transmissions are occurring. At step 74 a full sounding test is performed and the results are stored, and at step 75 the full sounding results are used to create a set of Interference Groups (IGs). At step 76, a baseline sounding test is performed after an appropriate interval, such as every hour, and at step 78 the results are compared to those measured at step 72 to determine whether a sufficient change in the baseline sounding results has occurred so as to warrant a full round of sounding. For example, a new cell tower installation, recently exposed cabling (which acts as an antenna), or signals from a nearby HAM radio operator may each affect baseline sounding measurements and full sounding measurements, and detecting the change in the baseline sounding results can be used to initiate a full sounding procedure. Alternatively, a new modem may have come online or gone offline, which for which a full round of sounding would be required to determine, at a minimum, which IG a new modem should be added to, or if removal of a modem would warrant splitting an IG. In any of these circumstances, the results measured by the baseline sounding procedure may have included a significant change, such as a change in noise registered by any individual modem in the service group over a set threshold, which would indicate that plant conditions had changed and would again warrant a new full sounding test. In any such circumstance where the comparison determines that a new round of full sounding is warranted, then at step 79 the new baseline results are stored and the procedure returns to step 74 where the full sounding is performed and so forth.

Conversely, if no significant change is observed between the baseline sounding results obtained at step 76 and the most previous baseline sounding results, then no changes to the IGs are needed and the procedure returns to step 76 where another baseline sounding is performed at the next scheduled interval. In some embodiments, a full sounding round may be triggered despite a lack of significant change in baseline sounding results if transmission errors are reported.

As noted earlier, baseline sounding results may change over time due to factors not related to system configuration changes (adding or removing modems, system maintenance on portions of the transmission network, etc.) or other such changes that would likely necessitate a change in interference groups. As one example, baseline sounding results may change based on time of day, ambient weather conditions such as temperature, and other similar factors. Therefore, some embodiments of the present disclosure may store a plurality of different historical baseline sounding results for different days of the week, different times of the day, different temperatures and other weather conditions etc. When a new baseline sounding round is performed, the most relevant one of the stored historical results may be retrieved for comparison.

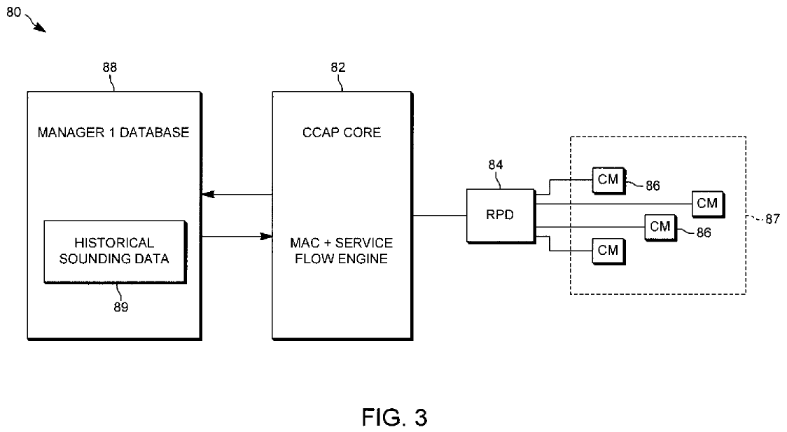

Referring to FIG. 3, for example, such an embodiment may comprise a system 80 that includes a CCAP core 82 connected to a plurality of cable modems 86 at premises of customers via a network of RPDs 84, where the cable modems 86 are assigned to interference groups 87 (only one of which is shown in FIG. 9). As with FIG. 1, the architecture of FIG. 3 is shown as an R-PHY system where the CMTS operates as the CCAP core while Remote Physical Devices (RPDs) are located downstream, but alternate systems may use a traditional CCAP operating fully in a CMTS in a head end, connected to the cable modems 4 via a plurality of nodes/amplifiers.

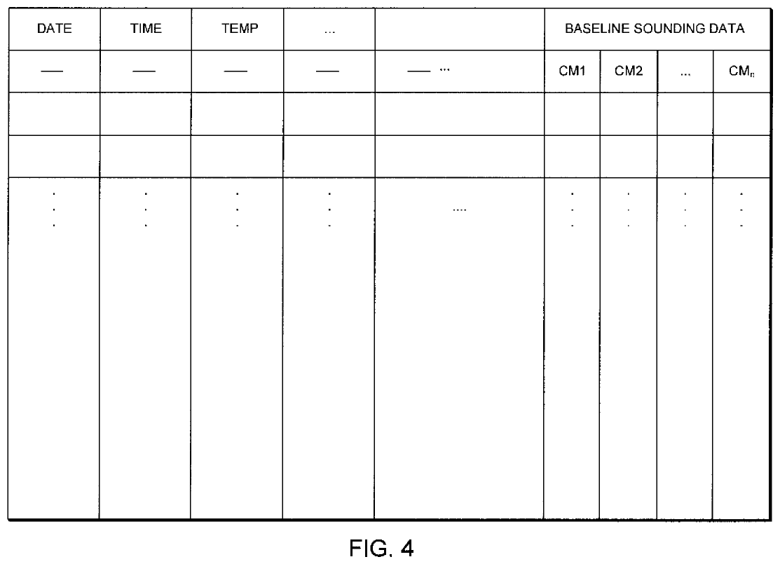

Preferably, the CCAP core 82 or other head end device may be connected to a database 88 that selectively stores historical sounding data in memory 89. FIG. 4 shows an exemplary scheme by which historical baseline sounding records may be stored. Specifically, each round of baseline sounding data may be stored as a record tagged with metadata indicating any or all of the dates (which may include the day of the week), the time that the baseline sounding data was collected, weather data such as temperature data corresponding to the location of the CCAP, the RPDs, and each of the cable modems, or any other factor deemed relevant to determining which stored historical baseline sounding record is most closely representative of conditions under which current baseline sounding data is to be compared. For example, if a current baseline sounding test is performed at 5:00 PM, the system 80 may retrieve the historical record that was made for 5:00 PM on the preceding day. In other embodiments, as more data is collected, if a current baseline sounding test is performed at 5:00 PM on a Wednesday, the system 80 may retrieve the historical record that was made for 5:00 PM on the Wednesday of the preceding week. As still more historical data is collected, the system 80 may be able to add more filters, such as temperature and other weather conditions, or other data so that, for example, a historical baseline sounding results may be retrieved that correspond to the same time of day and that most closely match the current weather conditions. In some embodiments, information such as weather conditions on a given date and time may be retrieved after baseline sounding is performed by accessing meteorological servers or other such available databases, and using the retrieved data to populate the baseline sounding records.

In a preferred embodiment, the database 88 with the historical sounding data 89 may be connected remotely to the CCAP core 82, but other embodiments may integrate the CCAP core 82 with the database 88. Similarly, some embodiments may include management or processing functionality with the database 88 remotely connected to the CCAP core 82 such that the CCAP core 82 simply initiates a request for a historical sounding record for comparison to current results, and the manager/database 88 determines the most relevant record and returns the results to the CCAP core 82.

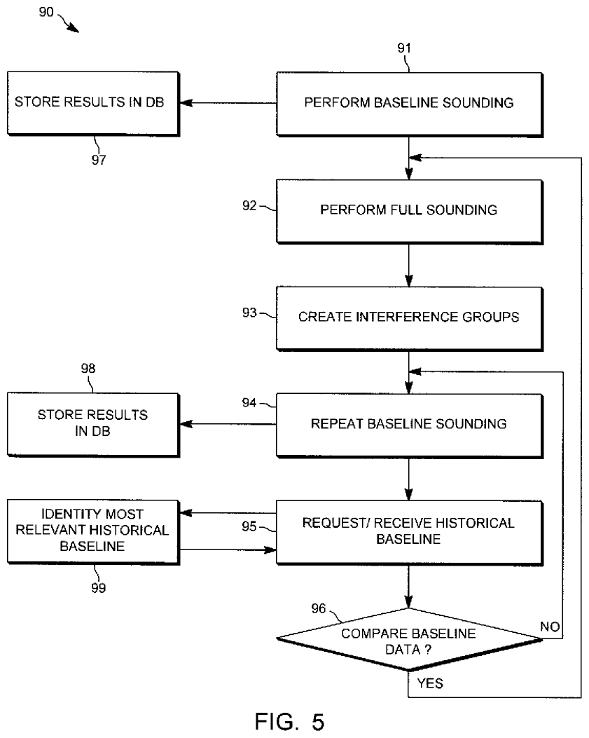

FIG. 5 illustrates an exemplary procedure 90 used by the system of FIG. 3. At step 91 baseline sounding is performed and the results are stored in a database at step 97. At step 92, a full sounding round is performed, and a set of interference groups are created at step 93 based on the results of the full sounding round. At step 94 another baseline sounding round is performed and the results are stored in the database at step 98. At step 95, a request for a historical baseline record from the database is made, and a result is identified and returned from the database at step 99. At step 96 a comparison is made between the historical record returned at step 99 and the current baseline sounding results obtained at step 94. If the comparison shows that another round of full sounding is warranted, the procedure returns to step 92, otherwise the procedure returns to step 94.

In some embodiments, the system and method shown in FIGS. 3 and 5 may employ a statistical model to make the determination about what differences between a current round of sounding and a historical baseline record warrant a new round of full sounding. Specifically, as the system and methods shown are first implemented, full rounds of sounding may be repeatedly gathered while the database 88 shown in FIG. 3 collects baseline sounding results, full sounding results, and information on whether new rounds of full sounding produce changes to Interference Groups. The system may then begin to correlate changes in metrics between a current baseline sounding reading and the most relevant historical record selected by the system (e.g. a maximum difference in baseline sounding reading for any modem) and a likelihood that a change was made in IGs. As more data is collected, the statistical model should become more reliable, and when a certain level of reliability is reached, the system may begin using baseline sounding readings as a proxy for a full sounding round after a desired threshold probability (e.g. 90%, 95% or any other desired threshold) is calculated that another full sounding procedure would produce a change in interference groups.

In other embodiments, system operators may determine empirically what qualitative and quantitative changes in baseline sounding readings are most likely to produce a need for a new round of full sounding.

In some embodiments of the disclosed system, the database 88 may store IGs associated with full sounding results and baseline sounding results, and may select a new IG based on records in the historical database without performing a full sounding test. For example, if there is insufficient bandwidth to perform a full sounding test, the baseline sounding test may be used as a proxy to temporarily select an IG.

Notably, when either the CMTS of a centralized CATV architecture, or an RPD/RMD of a distributed access architecture needs to be reset or otherwise rebooted, the Interference Group information is lost, and the sounding process historically has needed to be performed again to create optimal. This can be costly due to the system overhead and down-time that will be incurred from sounding large number of cable modems at once. This problem is further exacerbated then the CMTS/RPD/RMD services large number of nodes/cable modems.

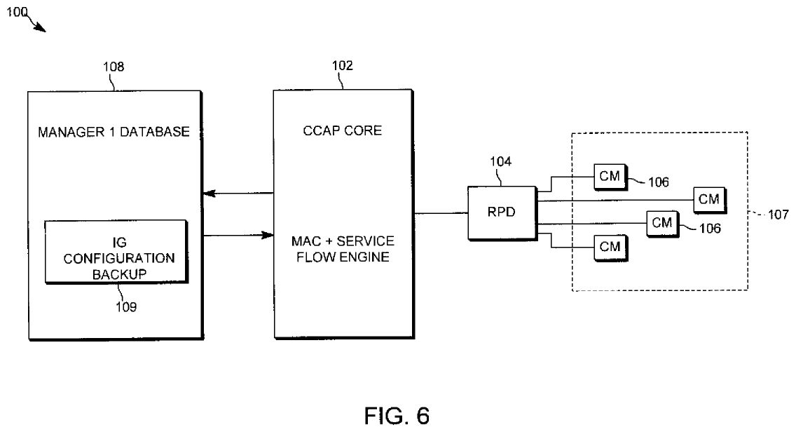

FIG. 6 shows an alternate architecture capable of quickly determining optimal interference groups following a system reset/reboot. Specifically, the system of FIG. 6 stores the latest optimal IG information in a central place that is protected (redundant). When a system reset/reboot occurs, then various systems can perform a ‘Bulk FDX IG query’ to recover the latest optimal IG configuration and ‘Bulk FDX IG injection’.

Specifically, such an embodiment may comprise a system 100 that includes a CCAP core 102 connected to a plurality of cable modems 106 at premises of customers via a network of RPDs 104, where the cable modems 106 are assigned to interference groups 107 (only one of which is shown in FIG. 6). As with FIGS. 1 and 3, the architecture of FIG. 6 is shown as an R-PHY system where the CMTS operates as the CCAP core while Remote Physical Devices (RPDs) are located downstream, but alternate systems may use a traditional CCAP operating fully in a CMTS in a head end, connected to the cable modems via a plurality of nodes/amplifiers.

In a preferred embodiment, the database 108 stores the latest optimal IG configuration in a redundant, secure location 109 that may simply be retrieved following a system reset/reboot, thus avoiding the time and complexity of performing additional rounds of sounding. The term “redundant” in this context means a secondary copy of the most recent, optimal Interference Group configuration in addition to a primary stored configuration that may be subject to loss during a system reset/reboot. The system shown in FIG. 6 has many benefits. First, it creates the optimal Interference Group configuration in bulk, and in one step as opposed to performing multiple sounding operations and averaging them/adjusting them until the optimal Interference Group configuration is obtained. Second, The Interference Group configuration is recovered quickly and therefore FDX services are resumed promptly. Third, the system overhead is reduced significantly, especially if the reboot is affecting large number of RPDs/nodes/subscribers. Fourth, Interference Groups for different nodes/legs/subscribers are all injected in the system in bulk.

In some preferred embodiments, the database 108 with the latest optimal IG configuration data in secure location 109 may be connected remotely to the CCAP core 102, but other embodiments may integrate the CCAP core 102 with the database 108. Similarly, some embodiments may include management or processing functionality with the database 108 remotely connected to the CCAP core 102 such that the CCAP core 102 simply initiates a request for a historical sounding record for comparison to current results, and the manager/database 108 determines the most relevant record and returns the results to the CCAP core 102.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A processing system in a CATV network having a plurality of cable modems, the processing system comprising:
a processor that selectively performs periodic sounding tests of the cable modems and determines an optimal interference group arrangement based on the sounding tests;
a memory that stores a redundant copy of the optimal interference group arrangement; where
the processor is capable of retrieving and implementing the optimal interference group arrangement following at least one of a system reset and a system reboot.

2. The processing system of claim 1 in a full duplex CATV architecture.

3. The processing system of claim 1 where the periodic sounding tests are a selected one of a CW test and an OUDP test.

4. A method implemented by a processor in a CATV network having a plurality of cable modems, the method comprising:
selectively initiating periodic sounding tests of the cable modems;
using the sounding tests to determine an optimal interference group arrangement;
storing a redundant copy of the optimal interference group arrangement; and
recovering the stored redundant copy of the optimal interference group arrangement following at least one of a system reset and a system reboot.

5. The method of claim 4 where the CATV system operates in a full duplex mode.

6. The method of claim 4 where the periodic sounding tests are a selected one of a CW test and an OUDP test.
